(19) United States
(12) Patent Application Publication
(10) Pub. No.: US 2026/0294600 A1
(43) Pub. Date: Oct. 1, 2026

(54) REUSABLE DENTAL FLOSSER

(71) Applicant: FLOSSYN LLC, Naples, FL (US)

(72) Inventors: Christopher WIDMER, Naples, FL (US); Michael DVORSAK, Bozeman, MT (US)

(73) Assignee: FLOSSYN LLC, Naples, FL (US)

(21) Appl. No.: 19/632,001

(22) Filed: Mar. 27, 2026

Related U.S. Application Data
(60) Provisional application No. 63/779,097, filed on Mar. 27, 2025.

(51) Int. Cl. A61C 15/04

(52) U.S. Cl. CPC A61C 15/046

(57) ABSTRACT

A dental flosser having a handpiece that includes a housing having a first chamber adapted for rotatably receiving a spool of dental floss therein, a pair of spaced-apart prongs located at a distal end of the housing, a passageway in the housing that communicates between the interior of the first chamber and the exterior of the housing, thereby allowing dental floss to extend from the spool of dental floss inside the first chamber to the pair of prongs, and a floss securement member for securing the floss such that a working portion of the floss can be tensioned between the prongs. A spool of dental floss is also provided.

### CROSS REFERENCE TO RELATED APPLICATIONS

This application claims priority to U.S. Provisional Patent App. No. 63/779,097, filed on Mar. 27, 2025, entitled “REUSABLE DENTAL FLOSSER.” The entire disclosure of the foregoing provisional patent application is incorporated by reference herein.

### BACKGROUND

Dental professionals recommend at least daily flossing to maintain proper dental health by removing plaque and other deleterious materials from between teeth and at the gumline. Floss is typically available in a floss dispenser containing a roll of dispensable floss and often a cutter for cutting the dispensed floss to the desired length. The length of floss is then tensioned between the user's fingers before being inserted between adjacent teeth.

Single use flossing devices are also available wherein the floss is tensioned between a pair of spaced-apart prongs. Such devices are typically discarded after a single use. Other flossing devices are available that include a roll of floss that is adapted to dispense a length of floss for tensioning between a pair of spaced-apart prongs similar to the single-use devices. However, these devices typically cannot be refilled once the roll of floss has been used up.

While a variety of devices and techniques may exist for providing a handheld, reusable dental flosser, it is believed that no one prior to the inventors has made or used an invention as described herein.

### BRIEF DESCRIPTION OF THE DRAWINGS

While the specification concludes with claims particularly pointing out and distinctly claiming the invention, it is believed that the invention will be better understood from the detailed description of certain embodiments thereof when read in conjunction with the accompanying drawings. Unless the context indicates otherwise, like numerals are used in the drawings to identify similar elements in the drawings. In addition, some of the figures may have been simplified by the omission of certain elements in order to more clearly show other elements. Such omissions are not necessarily indicative of the presence or absence of particular elements in any of the exemplary embodiments, except as may be explicitly stated in the corresponding detailed description.

FIG. 1 depicts an elevated perspective side view of one embodiment of a dental flosser of the present disclosure

FIG. 2 is a top view of the dental flosser of FIG. 1, with the access door in the open position.

FIG. 3 is the same view as FIG. 1, with the access door in the open position with no floss shown but depicting the floss spool mounted on the gear member.

FIG. 4 is a left rear view of the dental flosser of FIG. 3.

FIG. 5 is a right rear view of the dental flosser of FIG. 3.

FIG. 6 is an exploded side view of the dental flosser of FIG. 3.

FIG. 7 is an elevated perspective view of the bottom shell of the handpiece of the dental flosser of FIG. 1, including the gear member, lock, and biasing spring.

FIG. 8 is a top plan view of the bottom shell of FIG. 7.

FIG. 9 is the same view of the bottom shell of FIG. 7 without the gear member, lock, or biasing spring.

FIG. 10 is a top plan view of the bottom shell of FIG. 8 without the gear member, lock, or biasing spring.

FIG. 11 is a side view of the bottom shell of FIG. 9.

FIG. 12 is a proximal end view of the bottom shell of FIG. 9.

FIG. 13 is an elevated perspective view of the top shell of the handpiece of the dental flosser of FIG. 1.

FIG. 14 is a side view of the top shell of FIG. 13.

FIG. 15 is a top plan view of the top shell of FIG. 13.

FIG. 16 is a proximal end view of the top shell of FIG. 13.

FIG. 17 is an enlarged side view of the distal end of the second prong of the top shell of FIG. 13.

FIG. 18 is an elevated perspective view of the gear member of the dental flosser of FIG. 1.

FIG. 19 is a side view of the gear member of FIG. 18.

FIG. 20 is a top plan view of the gear member of FIG. 18.

FIG. 21 is a bottom plan view of the gear member of FIG. 18.

FIG. 22 is an orthogonal view of the spool of the dental flosser of FIG. 2.

FIG. 23 is a side view of the spool of FIG. 22.

FIG. 24 is a top plan view of the spool of FIG. 22.

FIG. 25 is an orthogonal view of the lock of the dental flosser of FIG. 6.

FIG. 26 is a top plan view of the lock of FIG. 25.

FIG. 27 is an orthogonal view of the cutter of the dental flosser of FIG. 1.

FIG. 28 is schematic top view of the dental flosser of FIG. 1 depicting the routing of floss.

FIG. 29 is a schematic side view of the dental flosser of FIG. 28 rotated 90°as compared to FIG. 28.

The drawings are intended to illustrate rather than limit the scope of the present invention. Embodiments of the present invention may be carried out in ways not necessarily depicted in the drawings. Thus, the drawings are intended to merely aid in the explanation of the invention. Thus, the present invention is not limited to the precise arrangements shown in the drawings.

### DETAILED DESCRIPTION

The following detailed description describes examples of embodiments of the invention solely for the purpose of enabling one of ordinary skill in the relevant art to make and use the invention. As such, the detailed description and illustration of these embodiments are purely illustrative in nature and are in no way intended to limit the scope of the invention, or its protection, in any manner. It should also be understood that the drawings are not to scale and in certain instances details have been omitted, which are not necessary for an understanding of the present invention.

Embodiments of the present disclosure provide a reusable dental flosser for assisting the user in the proper flossing of their teeth, as well as storing unused floss neatly inside the flosser. Like other flossing devices, the dental flosser of the present disclosure includes features that facilitate bringing the floss to the interproximal area of teeth in a convenient fashion. However, embodiments of the present disclosure allow for the removal and replacement of disposable floss holders, such as in the form of a spool of floss (a length of floss wound around a spool). When the floss on a floss holder has been consumed, only the floss holder is replaced. The handpiece of the flosser is reused by inserting a fresh spool of floss into the handpiece.

In one embodiment, including that shown in the figures, the floss holder (e.g., a cylindrical spool) having a length of unused floss is loaded into a housing of the handpiece. A free end of the unused floss is pulled from the housing, causing the holder to rotate and release floss. In some embodiments, the dental flosser includes a lock for selectively allowing floss to be released from the floss holder. In these embodiments, floss cannot be pulled from the floss holder unless the lock is released. The free end of the floss is passed through a passageway that communicates with the interior of the housing such that the floss extends towards the distal end of the flosser and the free end of the floss can be passed over and around a pair of spaced-apart prongs that extend distally away from the housing. In some embodiments, grooves for receiving and routing the floss are provided in the outer surfaces of the spaced-apart prongs. Downstream of the prongs, the floss is pulled taut and then secured to a securement member {anchor, cleat} under tension such that a working portion of floss extends between the spaced-apart prongs, under tension, for use in cleaning an interdental space. In some embodiments the securement member is a projection on the handpiece housing to which the floss can be secured in order to tension (make taut) the floss. For example, a cleat having a pair of opposed horns is provided such that the floss can be looped over and around the horns similar to the manner in which a rope is secured to a cleat on a boat.

After each use of the working portion of floss, whether to clean a single interdental (or interproximal) space or multiple interdental spaces, the working portion of the floss (i.e., the floss extending between the spaced-apart prongs) can be replaced with a fresh portion of floss. A fresh length of floss can be pulled from the housing and passed over and around the pair of spaced-apart prongs so as to provide a clean working portion of floss for interdental cleaning. In contrast, many commercially available flossers are intended to use the same fixed piece of floss for the cleansing of multiple interdental spaces in the human mouth. Once a piece of floss cleans an interproximal area between two teeth, the floss is laden with bacterial plaque. Bringing this same piece of floss to a different area in the mouth (as in another interproximal space that the user aims to clean by flossing) allows transmission of bacterial plaques to additional sites in the mouth, making such flossers a poor hygienic tool. The dental flosser described herein facilitates the use of a fresh working portion of floss to clean each interproximal space. The user can advance the used piece of floss out of the working region of the device after the user has cleaned each individual interproximal space. Activation (release) of the lock of the handpiece allows a fresh working portion of floss to be positioned in the working region of the device (i.e., between the spaced-apart prongs). This significantly improves the hygiene benefit to the end user provided by flossing.

In some embodiments, the floss holder comprises a replaceable spool about which the floss is wound. The floss spool is received within the housing such that the spool rotates in order to release (unwind) floss from the spool. The lock comprises a spool lock for selectively unlocking and allowing rotation of the floss spool within the housing, with the spool lock biased towards the locking position. Activation of the spool lock (e.g., by pressing an external arm of the spool lock) releases the spool to allow the spool to rotate and release floss. This allows a length of fresh floss to be pulled from the housing and passed over and around the pair of spaced-apart prongs.

As used herein, floss that has not yet been used to clean a tooth surface or an interproximal space will be referred to as “new,” or “clean,” or “fresh.” Floss that has already been used to clean any tooth surface or interproximal space will be referred to as “old,” or “used,” or “dirty.”

Embodiments of the dental flosser described herein are also reusable. Embodiments of the present disclosure allow for the removal and replacement of disposable floss holders, such as in the form of a spool of floss (a length of floss wound around a spool). When the floss in a floss holder has been consumed or there is an insufficient length of remaining floss for use in cleaning, only the floss holder is replaced. The handpiece is reused. The depleted floss holder is removed from the housing and replaced with a new floss holder containing fresh floss. This allows for reduction in environmental waste. A University College London sponsored study by Rawan Abed et al. found that single use interdental floss picks had the largest environmental footprint in 13 of 16 impact categories (Abed R, Ashley P, Duane B, Crotty J, Lyne A. An environmental impact study of inter-dental cleaning aids. J Clin Periodontol. 2023 January; 50(1):2-10. doi: 10.1111/jcpe.13727. Epub 2022 Oct. 6. PMID: 36122929; PMCID: PMC10092584.) With embodiments of the present disclosure, only the small floss-containing holder is removed and discarded. This significantly reduces the waste produced from regular floss use and is expected to contribute to reduced environmental harms as compared to the commercially available single-use alternatives on the market.

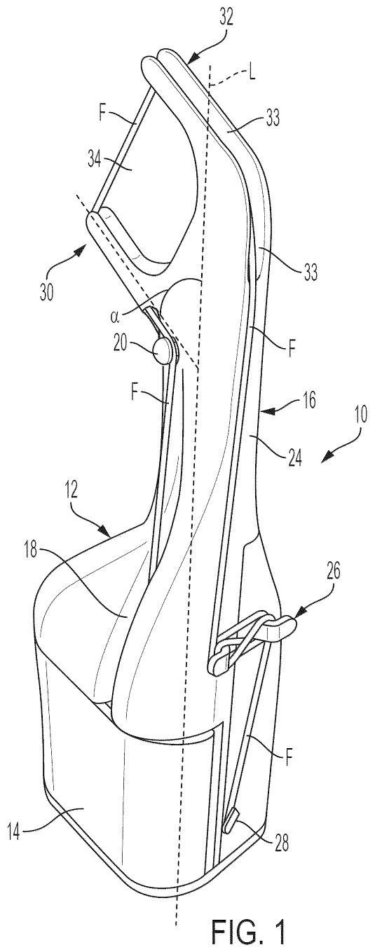

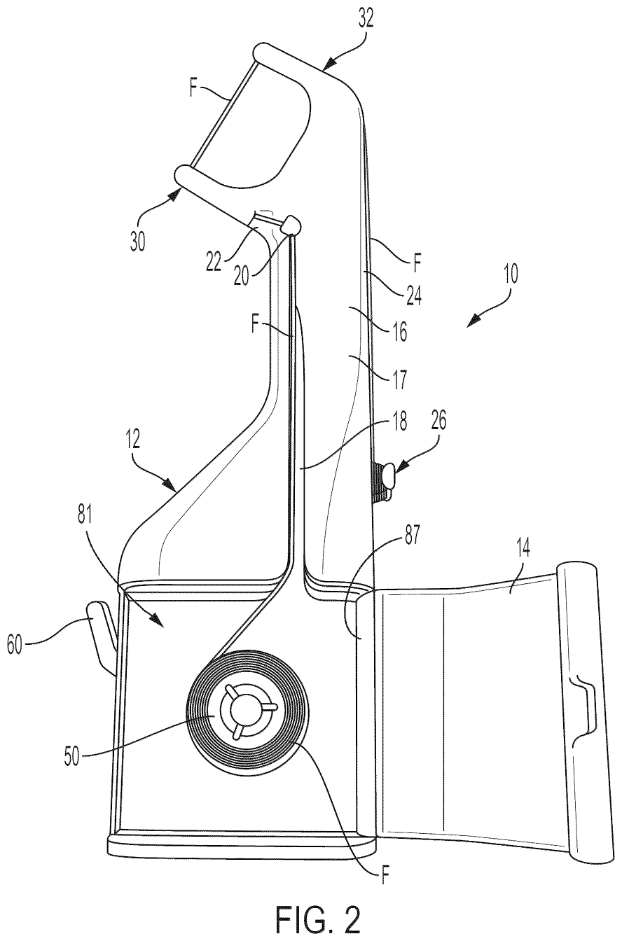

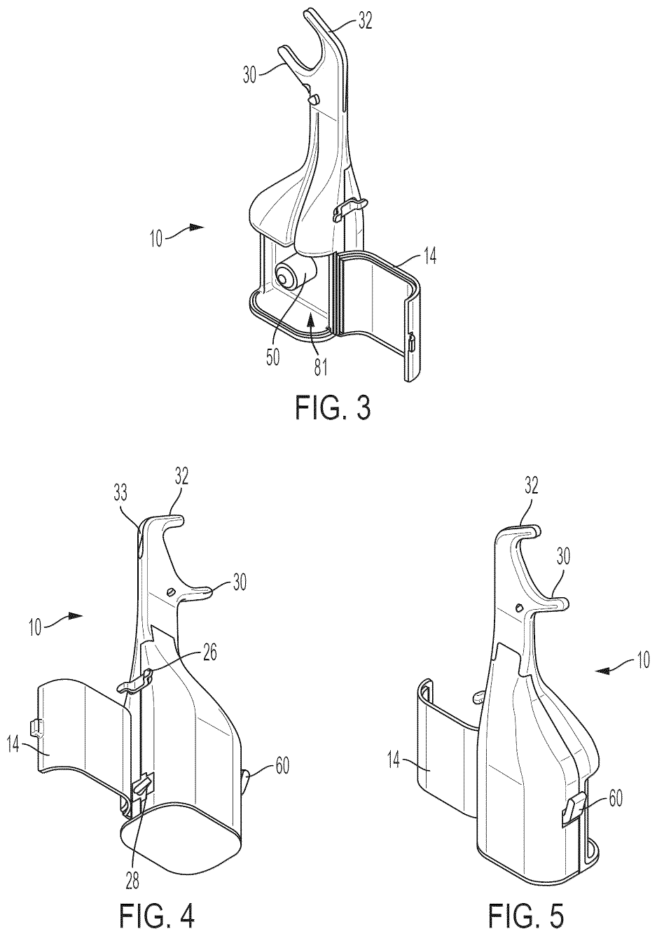

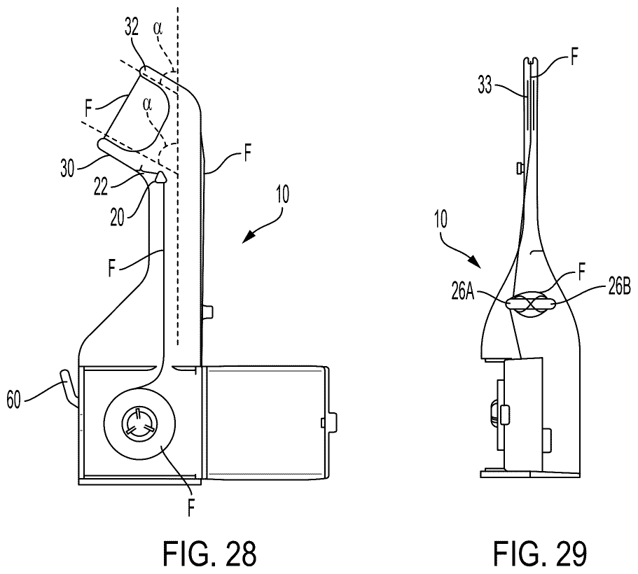

FIG. 1 depicts an elevated perspective view of one embodiment of a dental flosser of the present disclosure. The dental flosser comprises a handpiece 10 having a housing 12 defining a pair of enclosed volumes (e.g., first and second chambers), and a pair of spaced-apart prongs 30, 32 located at a distal end of the handpiece. FIG. 2 is a top view of the dental flosser, with an access door 14 of the housing 12 in the open position and a floss holder loaded within an interior volume of the housing. FIGS. 3-5 depict additional views of the dental flosser, with the access door open and floss holder 50 mounted for rotation within the housing (with no floss depicted on the floss holder for clarity). An elongate arm 16 extends between the housing 12 and the prongs 30, 32, with the prongs extending away from a distal end of the arm 16. In the particular embodiment shown, the arm 16 has a longitudinal axis L and the prongs 30, 32 extend away from the distal end of the arm 16 at an included angle α with respect to the axis L of between about 15 and about 45 degrees, between about 20 and about 40 degrees, or about 30 degrees. (The included angle α is identified in FIGS. 1 and 28.) The prongs 30, 32 extend generally parallel to one another in the depicted embodiment such that a U-shaped space 34 is provided between the prongs. In an alternative embodiment the prongs diverge away from one another so as to form a Y-shaped space between the prongs.

In some embodiments, the flosser comprises a molded polymer, particularly a durable plastic. By way of example, in some embodiments, the handpiece is made from ABS (Acrylonitrile Butadiene Styrene) plastic or polypropylene (e.g., K1011 polypropylene homopolymer), particularly FDA-approved ABS or propylene. In some embodiments, the gear member and spool lock (described below) are made from a more rigid plastic such as a polyoxymethylene (POM) plastic (e.g., DELRIN® brand plastic).

FIGS. 1 and 2 also depict the routing of floss F, wherein the floss extends out of the interior of the housing 12 of the handpiece. In FIG. 2, a floss holder, in the form of a spool 50 of floss F, is located within the interior of the housing 12. As described further herein, spool 50 is mounted for rotation (i.e., rotatably mounted) within the housing 12 such that floss can be released (unwound) from the spool. A spool lock 60 is also provided for inhibiting rotation of the spool in order to prevent the unintended release of floss. This also allows the floss to be wrapped around the prongs under tension. As described further herein, the spool lock 60 is biased to its locking position but can be disengaged by the user to allow the release of floss from the spool.

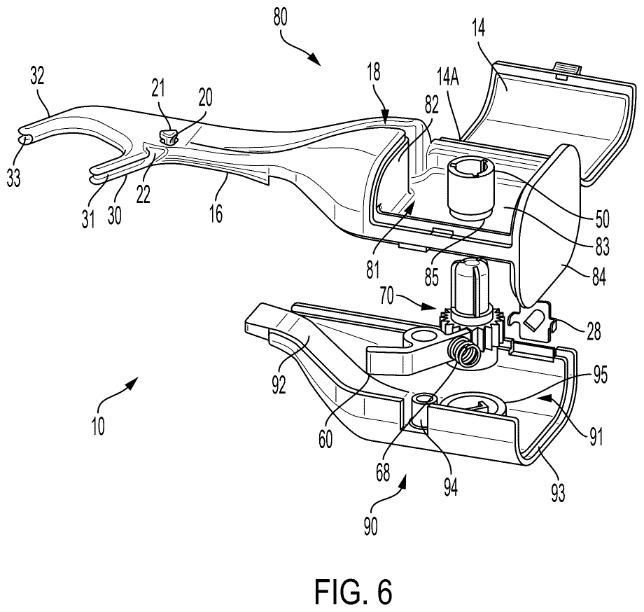

Floss from the spool 50 extends out of the interior of the housing 12 through a passageway 18 that communicates between the interior and exterior of the housing. In the embodiment shown, the passageway extends generally parallel to the axis L of the arm 16. The passageway 18 extends from a distal edge of the access door 14 towards the prongs 30, 32. The passageway 18 decreases in depth in the distal direction due to the tapering of the thickness of the housing 12 in the distal direction (i.e., towards the arm 16). In the particular embodiment shown, the passageway 18 is in the form of an open channel in the side of the handpiece that also extends along at least a portion of upper wall 17 of the arm 16 in order to guide the floss F towards the prongs (see also FIGS. 3, 6, and 15). In the embodiment shown, the channel 18 extends generally parallel to the longitudinal axis L of the arm 16 along the entire length of the channel. However, this is merely exemplary. The floss F extends distally through the channel 18, along the upper wall 17 of the arm 16, and around a guide member 20 protruding away from the upper wall 17 adjacent the juncture of the first prong 30 and the arm 16. In the embodiment shown, the guide member is in the form of a post 20, and includes an upper wall 21 (see FIGS. 6 and 14) overhanging the post. The upper wall helps prevent the floss from escaping the post (e.g., when the floss is not under sufficient tension).

After traversing around the guide member, the floss passes over the outer surfaces of and around the distal ends (or tips) of the first and second prongs 30, 32. As further described herein, a groove extends along the outer surface of each prong and around the tip of each prong, with the floss received within the grooves. In the embodiment shown, a cutaway 22 (best seen in FIG. 6) is provided in the upper wall 17 of the arm 16 immediately adjacent the first prong 30 to facilitate entry of the floss into the groove 31 in the outer surface of the first prong 30 (see FIG. 2). After leaving the groove 33 in the outer surface of the second prong 32, the floss extends in the proximal direction along the arm 16. In the embodiment shown, the floss extends proximally along the first sidewall 24 of the arm 16. A securement member 26 is located on the handpiece proximal to the prongs. In the depicted embodiment, the securement member is located on the top surface of the housing 12 proximal to the arm 16. The securement member in this embodiment comprises a cleat, around which the floss is looped in order to secure the floss in the position shown in FIGS. 1 and 2 under tension. A floss cutter 28 is optionally provided on the housing 12, proximal to the securement member 26. The floss cutter 28 is used to cut the floss such that used or excess floss can be removed and discarded.

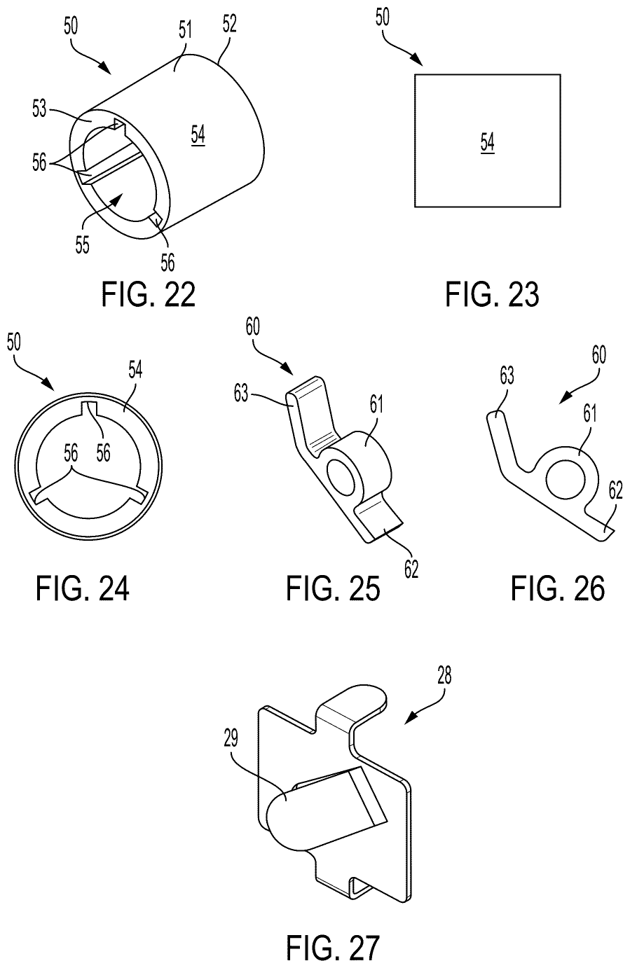

As mentioned above, the floss F is wound around a spool 50 shown in FIGS. 22-24. The spool comprises a cylindrical member 51 having an upper end 52, a lower end 53, a cylindrical outer surface 54, a cylindrical bore 55 extending between the upper and lower ends and having a surface, and at least three grooves 56 in the surface of the cylindrical bore. The grooves 56 extend axially between the upper and lower ends of the cylindrical member. The spool 50 is removably and rotatably mountable within the housing 12. The floss F is wound around the cylindrical member 51, and the inner end of the floss may be secured to the cylindrical member such as using tape or an adhesive in order to facilitate winding of the floss and prevent the floss from slipping off of the spool, particularly when only a small amount of floss remains.

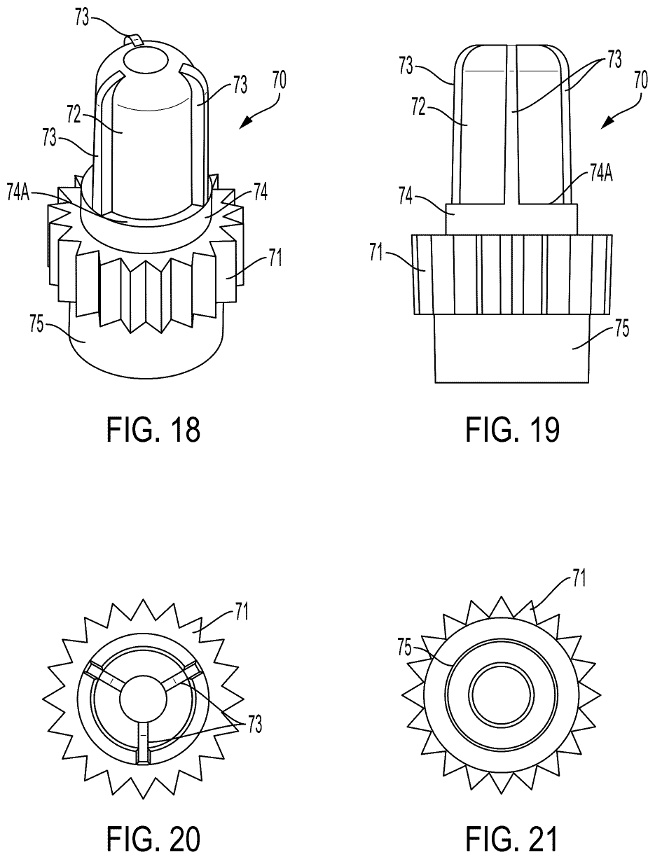

The spool 50 is rotatably mounted within the housing on the shaft of a gear member 70. As best seen in FIGS. 18-21, the gear member 70 includes a gear 71—in the depicted embodiment, a spur gear. A splined shaft 72 extends upwardly away from the gear 71, with the axis of the splined shaft axially aligned with the axis of the gear 71. A plurality of splines 73, in this instance three splines, extend longitudinally along the exterior of the splined shaft 72. As best seen in FIG. 18, the portion of the shaft 72 and the splines 73 are curved, with the curved upper end portion of the splined shaft terminating in a flat upper end. A cylindrical collar 74 is located at the base of the splined shaft 72 and has an outer diameter equal to the outer diameter of the splines 73. The splined shaft 72 is sized and configured such that the shaft 72 is received within the cylindrical bore 55 of the spool 50, with the splines 73 received within the grooves 56 in the interior of the bore 55. In the embodiment shown, when the spool 50 is mounted on the gear in this manner, the lower end 53 of the spool rests upon the upper surface 74A of the collar 74, with the outer diameter of the spool slightly larger than the outer diameter of the collar 74 (see FIG. 6). A mounting cylinder 75 extends downwardly away from the gear 71, with the axis of the mounting cylinder 75 axially aligned with the axis of the gear 71. As explained below, the mounting cylinder is received within a similarly shaped rotation cavity 95 within the bottom shell of the housing.

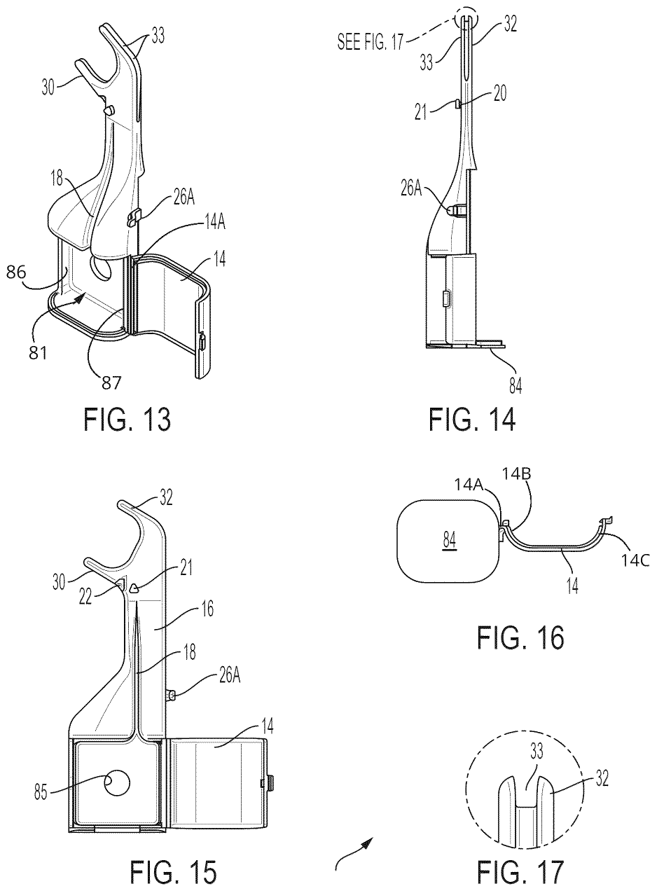

As best seen in FIGS. 6-17, the depicted embodiment of handpiece 10 comprises a top shell 80 and bottom shell 90. The two shells are joined to one another along the sides of the housing of the handpiece, such as by sonically welding the molded plastic shells to one another about their peripheries or attaching the shells using an adhesive. Of course, other materials and construction methods may be used. The top shell 80 defines a first chamber 81 of the housing 12. Top shell 80 includes a bottom wall 83 and a proximal wall 84 connected thereto. A first (or upper) portion of the proximal wall 84 extends upwardly away from the bottom wall, and a second (or lower) portion of the proximal wall extends downwardly away from the bottom wall. First chamber 81 is defined by a front (or distal) wall 82, bottom wall 83, a rear (or proximal) wall defined by the first portion of proximal wall 84, opposed sidewalls 86, 87, and hinged access door 14. In the example shown, the door 14 is hingedly connected to the top shell 80 by a living hinge 14A that allows the door to be opened and closed. The opposite side of the door includes a latch for engaging a cutout on the opposite side of the top shell such that the access door can be maintained in a closed position. In addition, the opposed sidewalls 86, 87 do not extend the full height of the front wall 82 and rear wall 84. However, the access door 14 includes sidewall extensions 14B, 14C (see FIG. 16) that, together with sidewalls 86, 87 of the top shell defines the sides of the first chamber 81. In alternative embodiments, the sidewalls 86, 87 solely define the sides of the first chamber (i.e., the sidewalls 86, 87 have the same height of the front wall 82 and rear wall 84) and the access door does not include the sidewall extensions. An aperture 85 is provided in the bottom wall 83 of the first chamber 81 and is sized to receive the splined shaft 72 and collar 74 of the gear member 70 therethrough, from beneath the first chamber 81. In the embodiment shown, the diameter of the aperture 85 is less than the outer diameter of the spool 50 such that the spool cannot pass through into the bottom shell 90.

The passageway 18 in the form of an open channel opens into (i.e., communicates with) the first chamber 81 through the distal wall 82 of the first chamber, and towards the distal end of the top shell. The passageway 18 is also open to the outer surface of the top shell distal to the distal wall 82 and first chamber 81. The depth of passageway 18 at its proximal end corresponds to the height of the front wall 82 of the first chamber 81. That depth tapers in the distal direction as the thickness (height) of the housing 12 tapers in the distal direction (i.e., towards the arm 16). The arm 16 and prongs 30, 32 are only provided on the top shell, as shown. It will be understood, however, that the arm 16 and prongs 30, 32 can be provided by the bottom shell or by a combination of the top shell and the bottom shell.

The bottom shell 90 defines, at least in part, a second chamber 91 of the housing 12. Second chamber 91 is bounded by a bottom wall 92 of bottom shell 90, wherein at least a distal portion of the bottom wall 92 slopes upwardly in the direction of the distal end of the handpiece. The bottom shell further includes a pair of opposed sidewalls 96A, 96B (see FIG. 8), and an open proximal end bounded by proximal recess 93. As best seen in FIG. 6, the second (lower) portion of the proximal wall 84 of the top shell extends downwardly beyond the bottom wall 83 of the top shell. When the top and bottom shells are attached, the lower portion of the proximal wall 84 of the top shell is received in the proximal recess 93 of the bottom shell 90. In this manner, when assembled, the lower portion of the proximal wall 84 of the top shell 80 forms (defines) the proximal end wall of the second chamber 91. The underside of the bottom wall 83 of the top shell 80 defines the upper wall of the second chamber 91, and the opposed sidewalls 96A, 96B and bottom wall 92 further define the bounds of the second chamber. A cylindrical mounting post 94 extends upwardly away from the bottom wall 92 and is received within an aperture in the spool lock 60, as further explained herein. A cylindrical rotation cavity 95 also extends upwardly from the bottom wall 92 and is sized and configured to rotatably receive the mounting cylinder 75 of the gear member 70 such that the mounting cylinder can freely rotate within the cavity 95, thereby allowing the gear member to rotate.

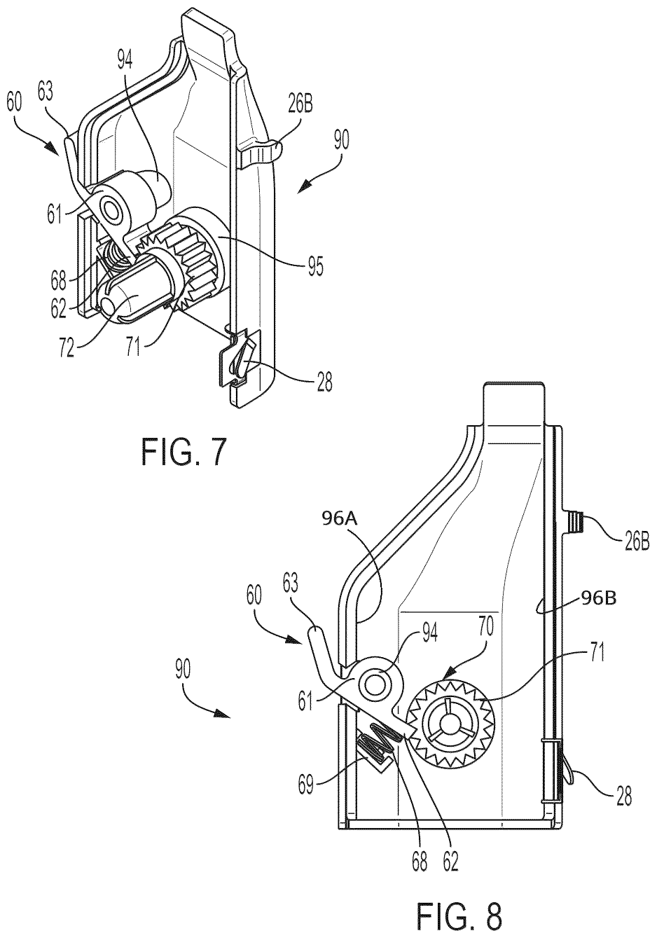

FIGS. 7 and 8 depict the arrangement of the gear member 70 and spool lock 60 for selectively releasing the spool in order to allow floss to be extracted from the spool, and locking the spool to allow the working portion of the floss to the tensioned between the distal tips of the prongs 30, 32. In the depicted embodiment, the spool lock 60 is in the form of a pawl, and comprises a pivot sleeve 61 having an aperture for receiving the mounting post 94 of the bottom shell therein such that the spool lock pivots about the mounting post. A lever arm 63 extends tangentially away from one side of the pivot sleeve 61, and a locking finger 62 extends tangentially away from the opposite side of the pivot sleeve 61.

The gear member 70 is mounted in second chamber 91 defined by the bottom shell 90 by sliding the mounting cylinder 75 into the cylindrical rotation cavity 95 of the bottom shell. The fit is sufficiently close to prevent substantial wobble of the gear member while also allowing the mounting cylinder 75 to freely rotate within the cavity 95. When the top and bottom shells are attached to one another, the splined shaft 72 and collar 74 of the gear member 70 extend through the aperture 85 in the bottom wall 83 of the top shell 80 into the first chamber 81 for receiving spool 50 on the splined shaft (see FIG. 6). Because the splines 73 are received within the grooves 56 in the interior of the spool 50, a spool mounted on the splined shaft can only rotate if the gear member also rotates.

When the spool lock 60 is mounted on the mounting post 94 as shown in FIGS. 7 and 8, the lever arm 63 extends through an opening in a sidewall of the second chamber 91 (i.e., a sidewall of the bottom shell 90) such that the lever arm is operable by the end user. The locking finger 62 is positioned within the second chamber 91 for operable engagement with the gear 71. Specifically, when the lever arm is pivoted away from the sidewall of the housing (FIG. 8), the external end of the locking finger engages the gear 71 between adjacent gear teeth, preventing rotation of the gear member. When the lever arm is pressed or squeezed towards the sidewall of housing (FIG. 7), the spool lock pivots such that the external end of the locking finger 62 is pivoted away from and out of engagement with the gear, releasing the gear member and allowing the gear member to rotate and hence the spool 50 can rotate (for pulling floss from the spool). When the spool lock is moved to its unlocked position, a user can pull floss toward the prongs, causing the spool to rotate is floss is pulled from the spool.

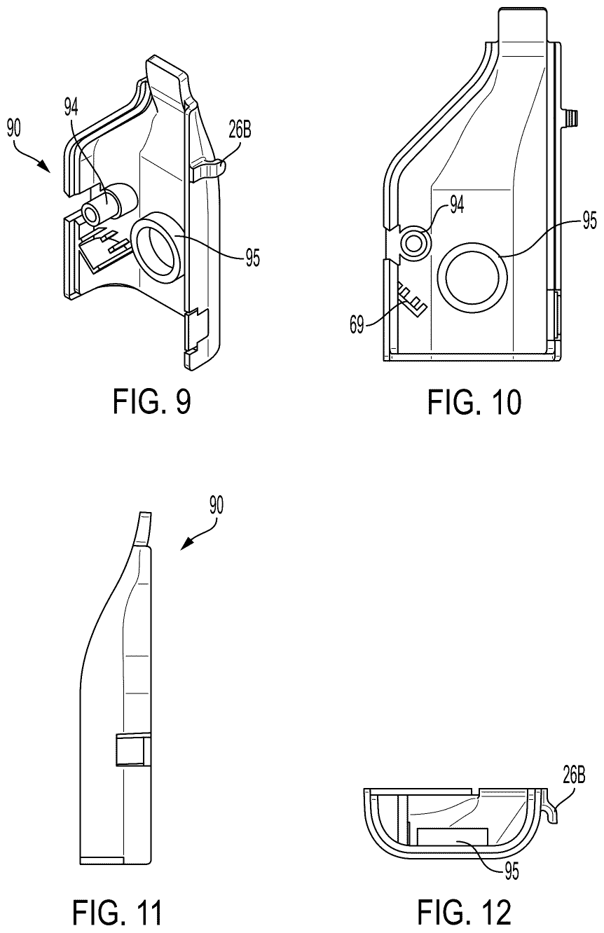

As also seen in FIGS. 7 and 8, the spool lock 60 is spring biased to the locked position (FIG. 8). In the depicted embodiment, a spring 68 located within the second chamber is in operative engagement with an internal wall of the bottom shell and a surface of the locking finger 62. As best seen in FIGS. 9 and 10, the internal wall that the spring engages is in the form of a spring retention cup 69 provided on the interior of the bottom shell. The spring retention cup 69 receives the spring therein, holding the spring in place and also providing an internal wall against which the spring 68 bears.

As mentioned previously, a securement member 26 is located on the flosser proximal to the prongs. In the depicted embodiment, the securement member comprises a cleat 26 located on a sidewall of the housing (e.g., a sidewall contiguous and coplanar with the first sidewall 24 of the arm 16). As shown, the cleat is bifurcated such that a first horn 26A of the cleat is provided on the top shell 80 and a second prong 26B of the cleat is provide on the bottom shell 90. The horns are located such that, when the top and bottom shells are combined, the first and second horns combine to form the cleat 26. As best seen in FIG. 27, the floss cutter 28 is stamped or formed from a metal plate that is cut to form a cutting tab 29 that is bent away from the metal plate. Floss can be passed beneath the cutting tab and pulled into an edge of the cutting tab or between the cutting tab and the metal plate so as to cut excess or used floss for disposal.

During use, a floss spool 50 containing fresh floss F is loaded into the first chamber 81 and mounted on the splined shaft 72. Thereafter, a free end of the floss is passed into and distally through the passageway 18 to the exterior of (and distal to) the housing. The access door 14 is then closed and is retained in the closed position by the latch (e.g., a latch molded into door and engaging a slot in the top shell), a friction fit, or other mechanism or feature. While deactivating the spool lock 60 (e.g., by pressing the lever arm 63 towards the sidewall of the housing), the free end of fresh floss is pulled from the spool through the passageway 18, along the upper wall 17 of the arm and then around the guide member 20. The floss is then pulled around the prongs 30, 32 such that the floss passes through cutaway 22 into the grooves 31, 33 on the outer surfaces of the prongs 30, 32, respectively. Groove 31 extends along the exterior surface of the first prong 30 and around the distal tip of the prong. Groove 33 extends around the distal tip of the second prong 32, along the exterior surface of the second prong 32 and along a portion of the first sidewall 24 of the arm 16 (see FIG. 1). When a sufficient length of floss has been released from the spool and pulled from the housing, the lever arm 63 is released, which causes the locking finger 62 to pivot back into engagement with the gear 71 under the force of the spring 68. This results in locking the gear member 70 from rotation, thereby preventing the floss spool 50 from rotating and releasing additional floss. The floss is then pulled taut, with the floss located in the grooves 31, 33 around the prongs. The length of floss proximal to the prongs is then looped around the securement member 26, such as in the manner shown in FIGS. 1 and 29, thereby securing the floss under tension for use in flossing. Any excess floss can be cut using the floss cutter 28 and disposed of.

After cleaning an interdental space, the used working portion of floss is replaced by pressing the lever arm 63 towards the housing, unlooping the floss from the securement member 26, and pulling the floss from the second prong along the first sidewall 24 of the arm 16 towards the securement member 26 to advance fresh floss into the space between the prongs 30, 32. The lever arm 63 is released, and the floss proximal to the second prong 32 is then attached to the securement member 16, such as by looping the free portion of the floss around the securement member as described previously. Once again, any excess floss, particularly used floss, can be cut and disposed of using the floss cutter 28.

While various embodiments of the reusable dental flosser have been described in detail above, it will be understood that the components, features and configurations, as well as the methods of manufacturing the devices and methods described herein are not limited to the specific embodiments described herein.

What is claimed is:

1. A dental flosser having a handpiece comprising:
(a) a housing including a first chamber having an interior adapted for receiving a spool of dental floss therein such that the spool is rotatable in order to supply dental floss from the spool;
(b) a pair of spaced-apart prongs located at a distal end of the handpiece, wherein a groove extends around at least a portion of each of the prongs including a distal tip of each prong, said grooves adapted for receiving floss therein;
(c) a passageway in the housing, the passageway communicating between the interior of the first chamber and an exterior of the housing, thereby allowing dental floss to extend from the spool of dental floss inside the first chamber to said pair of prongs; and
(d) a floss securement member for securing the floss such that a working portion of the floss can be tensioned between the prongs, the floss securement member located on the housing proximal to the prongs.

2. The dental flosser of claim 1, further comprising a spool lock for locking rotation of the spool and selectively releasing the spool to allow rotation of the spool, thereby allowing floss to be extracted from the spool.

3. The dental flosser of claim 2, wherein the spool lock is spring biased towards a locking position for preventing rotation of the spool.

4. The dental flosser of claim 3, further comprising a gear member rotatably mounted within said housing, the gear member adapted for engaging the spool of dental floss.

5. The dental flosser of claim 4, wherein the gear member includes a gear and a splined shaft extending upwardly away from the gear.

6. The dental flosser of claim 5, wherein the spool lock comprises a pawl pivotally mounted within the housing for selective engagement with said gear.

7. The dental flosser of claim 1 wherein the housing includes a second chamber adjacent to, and in communication with, said first chamber.

8. The dental flosser of claim 7, wherein the housing further comprises a wall between the first and second chambers and having an aperture in said wall.

9. The dental flosser of claim 8, further comprising a spool lock for locking rotation of the spool and selectively releasing the spool to allow rotation of the spool, thereby allowing floss to be extracted from the spool, and a gear member rotatably mounted within said housing, the gear member adapted for engaging the spool of dental floss.

10. The dental flosser of claim 9, wherein a portion of the gear member extends from the second chamber into the first chamber through said aperture.

11. The dental flosser of claim 10, wherein the gear member includes a splined shaft located within said first chamber and adapted for receiving the spool of dental floss thereon.

12. The dental flosser of claim 11, further comprising an access door for accessing the first chamber for inserting the spool of dental floss into the first chamber.

13. The dental flosser of claim 11, wherein said floss securement member comprises a cleat.

14. A reusable dental floss holder having a handpiece comprising:
(a) a housing including first and second chambers, the first chamber having an interior adapted for rotatably mounting a spool of dental floss therein;
(b) an arm extending proximally away from the housing;
(c) a pair of spaced-apart prongs located at a distal end of the arm, wherein a groove extends around at least a portion of the prongs including a distal tip of each prong, said grooves adapted for receiving floss therein;
(c) a passageway communicating between the interior of the first chamber and an exterior of the housing, the passageway adapted to receive dental floss from the spool of dental floss;
(d) a gear member rotatably positioned within the second chamber, a portion of the gear member extending through a wall of the housing into the first chamber, wherein the portion of the gear member extending into the first chamber is adapted for receiving the spool thereon;
wherein the gear member is selectively rotatable to allow the spool to rotate for releasing floss from the spool.

15. The reusable dental floss holder of claim 14, wherein said passageway comprises an open channel in an exterior wall of the housing, the open channel adapted to receive dental floss from the first chamber, the open channel communicating with the first chamber through a distal wall of the first chamber and extending through the housing towards the distal end of arm.

16. The reusable dental floss holder of claim 15, wherein the handpiece comprises a top shell and a bottom shell secured to one another, wherein the first chamber is defined by the top shell and the second chamber is at least partially defined by the bottom shell.

17. The reusable dental floss holder of claim 16, wherein the top shell includes a bottom wall and a proximal wall connected thereto, a first portion of the proximal wall extending upwardly away from the bottom wall and a second portion of the proximal wall extending downwardly away from the bottom wall, wherein the first portion of the proximal wall of the top shell defines a read wall of the first chamber and the second portion of the proximal wall of the top shell defines a rear wall of the second chamber.

18. The reusable dental floss holder of claim 17, wherein the portion of the gear member extending through a wall of the housing into the first chamber extends through the bottom wall of the top shell.

19. The reusable dental floss holder of claim 18, further comprising a floss securement member for securing the floss such that a working portion of the floss can be tensioned between the prongs, the floss securement member located on the housing proximal to the prongs.

20. A spool of dental floss comprising:
(a) a cylindrical member having an upper end, a lower end, a cylindrical outer surface, a cylindrical bore extending between the upper and lower ends and having a surface, and at least three grooves in the surface of the cylindrical bore, said grooves extending axially between the upper and lower ends of the cylindrical member; and
(b) a length of dental floss wrapped around an outer surface of the cylindrical member.
